(19) United States
(12) Patent Application Publication
(10) Pub. No.: US 2005/0242699 A1
(43) Pub. Date: Nov. 3, 2005

(54) Internal magnetic shield for crt

(76) Inventors: Ludovic Peter Willem Huysmans, Eindhoven (NL); Wilhelmus Marinus Maria Van De Steen, Eindhoven (NL); Jean Winters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,473

(22) PCT Filed: Apr. 29, 2003
(86) PCT No.: PCT/IB03/01778

§ 371 Date: Nov. 22, 2004

(30) Foreign Application Priority Data
May 24, 2002 (EP) 02077048.3

(51) Int. Cl. H01J 29/86; H01J 29/92

(52) U.S. Cl. 313/477 R

(57) ABSTRACT

A ferromagnetic shielding funnel having a flange at its wider end for reception within the conical portion of a cathode ray tube, the funnel having support members at the corner portions of its flange. Each support member has a base plate which is attached to the flange and a distal end which has been bent into a V-shape for bearing on a respective pin in the wall of the cathode ray tube. For preventing that the funnel comes loose from the pins, the support members comprise further attachment means with which they are attached to a skirt of the flange. Preferably, the base plate is attached to the flange by means of two first connections to a flange portion which is parallel to a long side of the cone portion and two second connections to a flange portion which is parallel to a short side of the cone portion. The extreme ones of these connections are preferably arranged such that bending of the flange at the corner portions is prevented.

The invention relates to an Internal Magnetic Shield (IMS) for a cathode ray tube, having a cone portion with two long sides and two short sides, and a flange at the wider end of the cone portion, the flange having four corner portions, each corner portion being bevelled, a metal support member being arranged at each of said corner portions, each metal support member having a base plate which is parallel to and attached to the side of the flange which is remote from the cone portion and a distal end having an aperture.

The invention further relates to a CRT equipped with such an Internal Magnetic Shield.

CRTs for color television, computer monitors and other display applications rely on a cathodoluminescent phosphor screen to provide a visible display. Such a screen is composed of a repetitive pattern of a large number of small red, blue and green-emitting phosphor elements, which are excited to luminescence by electron beams emanating from an electron gun behind the screen. There are three beams, i.e. one for each of the red, blue and green components of a color display signal. In operation, the screen is repetitively scanned by the three beams simultaneously, while the intensities of the beams are modulated by the respective individual primary color components of the display signal. The large number of phosphor elements, together with the scanning frequency, results in the perception of a steady, full color display by a viewer.

Such CRTs typically employ a color selection means, like a shadow mask. A shadow mask is a thin sheet having a large number of apertures and mounted between the phosphor screen and the electron gun, a short distance behind the screen. The apertures are aligned with the phosphor elements on the screen and the electron beams are directed from the electron gun to converge at the mask. When the beams pass through the individual apertures, they diverge from one another to land on the phosphor element of the corresponding color.

The mask, which is typically 0.15 to 0.25 mm thick, is supported on a frame to maintain its shape. This frame is then securely mounted in the glass envelope in order to maintain the mask in proper registration with the screen. Such registration must not only be maintained in the X and Y directions, but also in the Z direction, i.e., along the tube axis in order to insure that the beams do not land on adjacent phosphor elements, which would degrade the color purity of the display image.

Particularly during the warm-up period, the mask heats up and expands in all directions. Once the frame also warms up, the thermal compensation effect of the suspension system takes place, moving the whole mask closer to the screen, and maintaining overall color purity by bringing all of the mask apertures back into the electron beam path. When the temperature differential between the mask and frame is large during initial warm-up, the time required for thermal compensation is longer. This differential is minimized by using a frame of as low a mass as possible.

A common technique to maintain the proper Q space (distance between mask and screen) during tube warm-up has been to employ a so-called “corner lock” suspension system, in which corner lock mechanisms, each of which include thermal compensation means, are attached to the four corners of the frame. This results in a more stable arrangement than that achievable using the side mounting arrangement, thereby enabling use of a lighter and less costly mask and/or frame.

A current mask suspension system is described in WO 99/34391. This system employs corner brackets welded to lightweight diaphragm strips to form a rectangular frame; each diaphragm strip has an angular cross section formed by a base section and an upright section to which the shadow mask is welded. A resilient plate, also referred to as a temperature compensating plate or as a hinge plate, is fixed to each corner plate by a spring which loads it toward a pin embedded in a corner of the skirt adjacent to the face plate. The pin is engaged by a floating washer mounted to the hinge plate. During assembly, the floating washers are welded to the hinge plates after the mask/frame assembly is engaged to the pins. The phosphor elements are then applied in a photo-lithographic screening process, which involves removing and replacing the assembly several times. After a conductive coating is applied to the phosphor elements, the assembly is fixed in place by welding the floating washers to the studs. The Internal Magnetic Shield is fixed to the frame by means of dart clips received through apertures in the corner plates.

Drawbacks of the known system are a/o. reduced image quality and a difficult to control microphony behavior, which is attributed to the specific way (mechanically coupled to the shadow mask frame) in which the Internal Magnetic Shield is supported in the CRT.

A mechanically de-coupled system, involving mounting of the Internal Magnetic Shield on the pins, has been proposed as an alternative, a drawback being however that under the influence of shocks the Internal Magnetic Shield tends to come loose from the pins, resulting in instability of the system.

According to the invention an Internal Magnetic Shield largely overcoming these drawbacks is characterized in that the distal end of each support member has been bent into a V-shape, the aperture being arranged in the portion of the distal end which is remote from the base plate.

This construction of the support members makes it possible to place them with a certain bias (load) on the pins, the aperture in the distal end engaging the pin (direct mounting) or engaging a formed boss (dome) which connects the adjacent mask support means to its pin (indirect mounting).

A further embodiment is characterized in that the flange has a skirt, the bevelled corner portions however being skirtless, the metal support member comprising at least one further attachment portion, which is normal to the flange and is attached to the skirt. This construction improves the ability of the system to withstand heavy bumps. If the Internal Magnetic Shield support members are only attached to the flange, as in the prior art, they appear to break off sometimes in a bump test.

The attachment of the Internal Magnetic Shield support members to the skirt may advantageously be carried out by providing the base plate with at least one portion which is bent away from the Internal Magnetic Shield cone portion and welding this to the skirt. Alternatively, the portion of the V-shaped distal end, which is adjacent the base plate is provided with a projection (leg) on at least one side and this leg is welded to the skirt.

According to a further embodiment the base plate itself is attached to the flange by means of two first connections to a flange portion which is parallel to a long side of the cone portion and two second connections to a flange portion which is parallel to a short side of the cone portion. This construction prevents local bending of the flange under the influence of a shock, which might cause the Internal Magnetic Shield to come loose.

A preferred embodiment to meet this object is characterized in that an imaginary line through those two of the first and second connections which are farthest from each other (the “extreme” connections), if outside the cone portion, has a distance to the adjacent corner of the cone portion of at most 5 mm. If the distance is zero, the imaginary line touches the cone portion. Preferably said imaginary line crosses the cone portion.

For an Internal Magnetic Shield which is to be supported in a CRT mechanically decoupled from the shadow mask frame like the inventive Internal Magnetic Shield, it is important that the periphery of the smaller end of the cone portion is closed. This improves the stability to withstand torsion, as compared to Internal Magnetic Shield designs the periphery at the smaller end of the cone portion of which is not closed. Torsion can cause the Internal Magnetic Shield to come loose or break off of one or more support members.

A fifth connection (weld) may advantageously be provided adjacent an imaginary line which connects diagonal corner portions of the flange.

The invention also relates to a CRT equipped with an Internal Magnetic Shield as described above. In particular said CRT has a shadow mask mounted on pins and the Internal Magnetic Shield is mounted through its support members on the same pins, the mounting being directly or indirectly.

Some embodiments of the invention will be described hereafter, with reference to the drawing, in which:

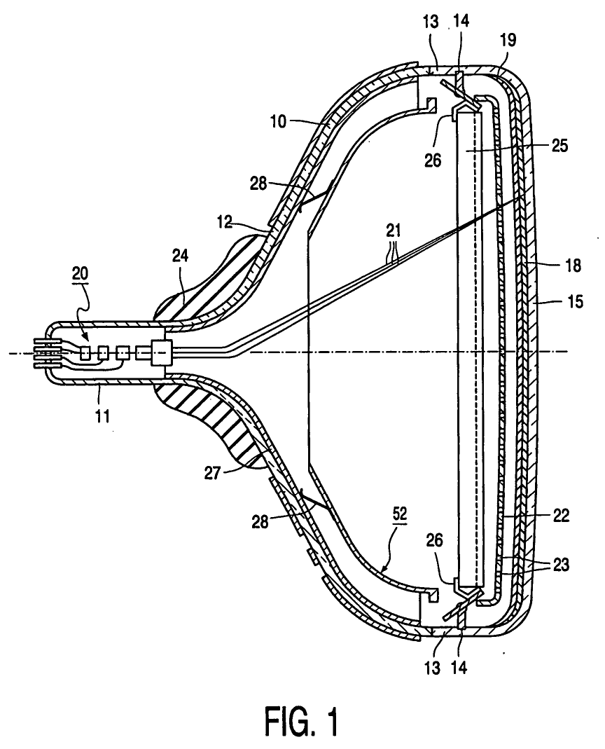

FIG. 1 is a sectional view of a cathode ray tube;

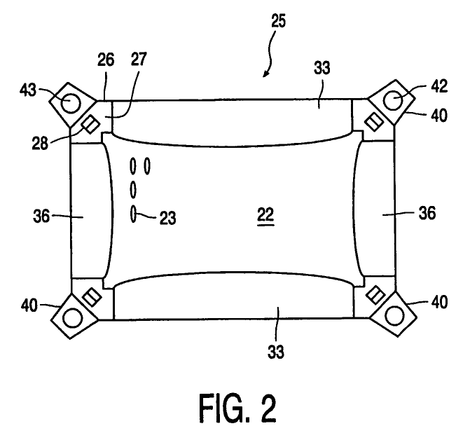

FIG. 2 is a plan view of the supporting frame and mask, seen from the rear;

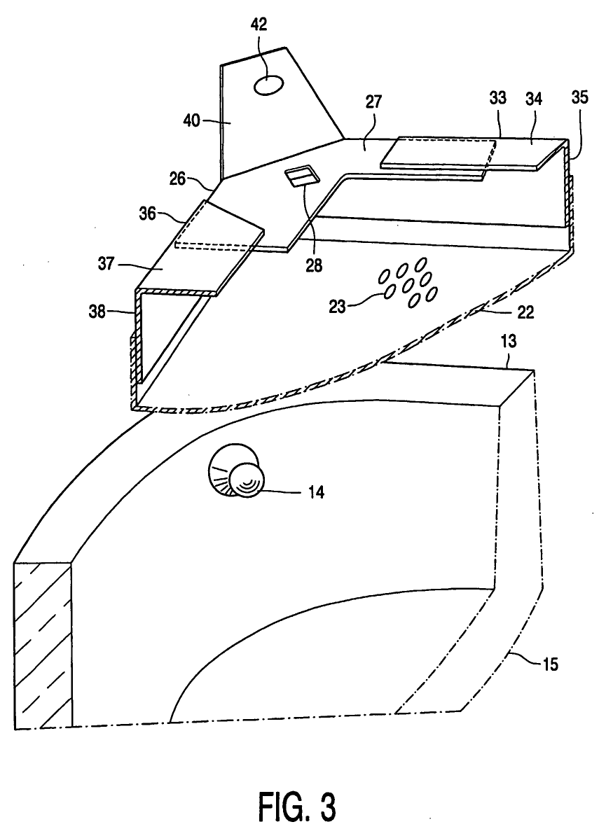

FIG. 3 is a partial perspective view of the corner bracket, frame, and mask exploded from the face plate;

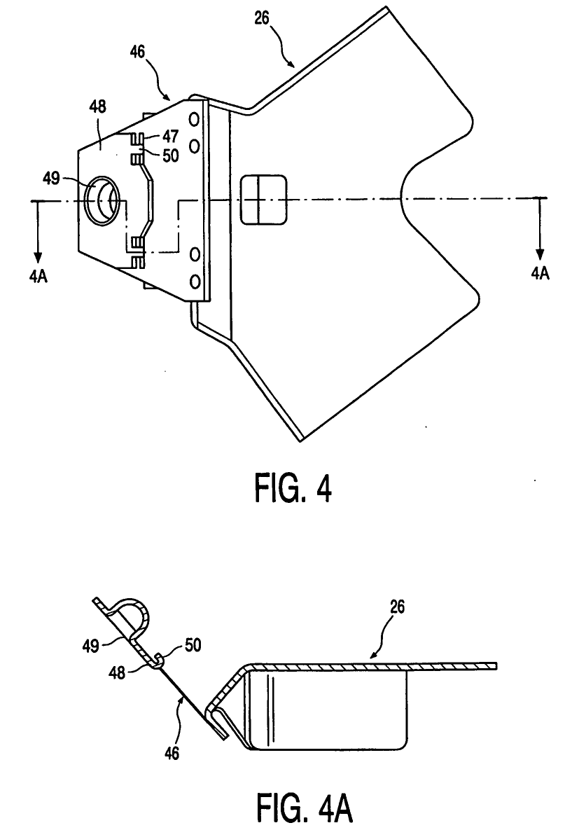

FIG. 4 is a plan view of a corner bracket and an embodiment of a temperature compensating plate;

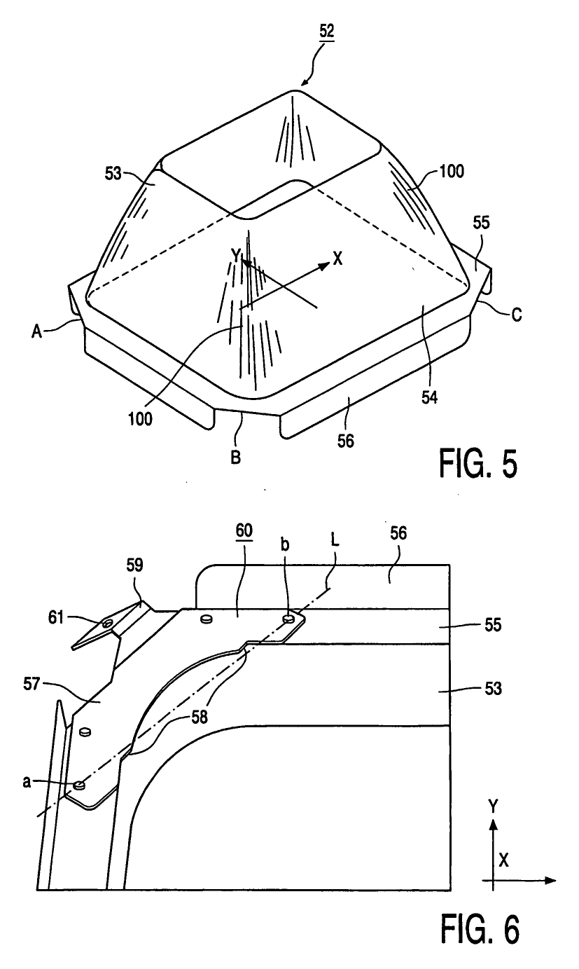

FIG. 5 is a perspective view of an Internal Magnetic Shield;

FIG. 6 is a partial perspective view of an Internal Magnetic Shield according to the invention with a first support member;

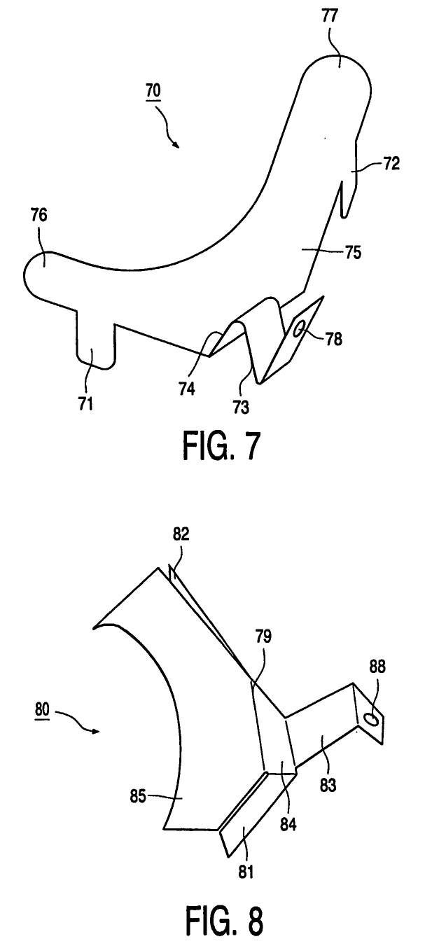

FIG. 7 is a perspective view of a second support member;

FIG. 8 is a perspective view of a third support member;

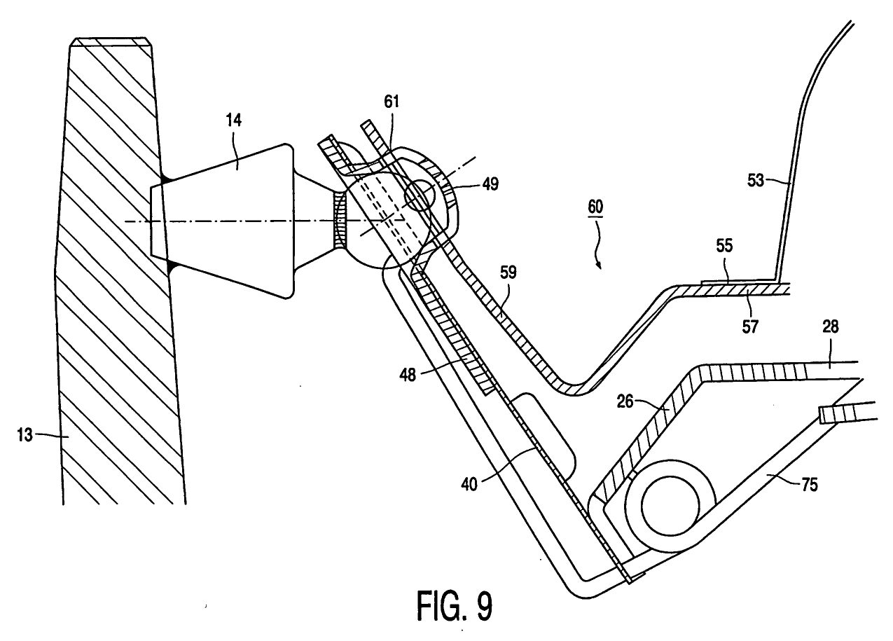

FIG. 9 is a partial sectional view of a CRT and a first corner pin support;

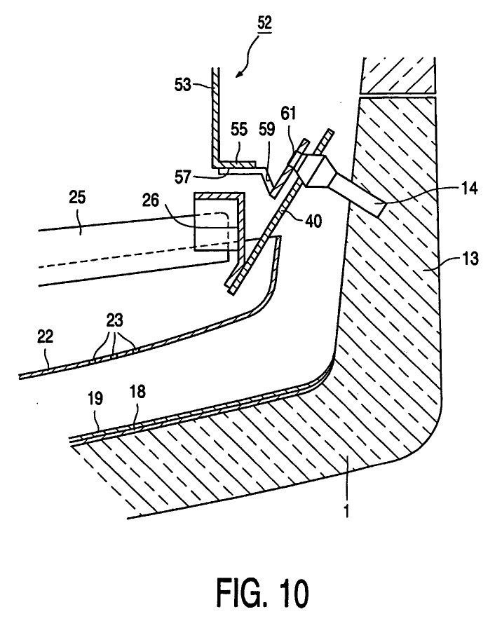

FIG. 10 is a partial sectional view of a CRT and a second corner pin support.

Referring to FIG. 1, a color display tube includes a glass vacuum envelope 10 having a neck 11, a funnel 12, a substantially rectangular face plate 15, and a skirt 13 extending between the face plate and the funnel. Mounting pins 14 embedded in the skirt adjacent the four corners of the plate serve to position the color selection electrode or shadow mask 22 with respect to the display screen 18 on the inside surface of the face plate 15. The display screen 18 is composed of a large number of red, green and blue luminescing phosphor elements which are covered with an aluminum coating 19. The elements luminesce when bombarded by electrons in the beams 21 emitted from an electron gun 20 mounted in the neck. The beams 21 are deflected by deflection coils 24, which are coaxially arranged about a longitudinal axis of the tube, and pass through apertures 23 in the mask 22 to illuminate the phosphor elements.

The mask 22 is welded to a supporting frame 25, which in turn is mounted on the pins 14. The frame 25 is provided with four corner brackets 26, each bracket 26 having a resilient plate 40 welded thereto, the plates 40 being loaded against the pins 14 to position the mask 22 and frame 25 with respect to the vacuum envelope 10. Internal magnetic shield 52 can be mounted in the envelope 10 in several manners, none of which is shown in this example. The shield 52 is connected to a metallic layer 27 on the inside of funnel 12 by spring loaded contact 56. This shields the electron beams from the earth's magnetic field and other interference.

FIG. 2 is a plan view of the mask 22 and frame 25 seen from the rear, i.e., the side opposite the display screen. In this example two long diaphragms 33 and two short diaphragms 36, all having angular cross sections, are welded to the corner brackets 26 to form a rectangle. Each of the diaphragms 33, 36 has a thickness of 0.2 mm to 0.4 mm, which closely matches the 0.2 mm thickness of the mask and assures a uniform expansion of the assembly during warm-up. The mask and diaphragms are preferably made of low carbon steel; the corner brackets, which are 0.5 to 0.8 mm thick, are either made of low carbon steel, nickel plated low carbon steel, or stainless steel. In this example the corner brackets 26 each have a rectangular hole 28 with a bent out lip for receiving a spring means for loading the frame support means against the pins.

The resilient plates 40, which accommodate to thermal expansion and are also referred to as temperature compensation plates, are welded to respective corner brackets 26 and extend toward the viewer as cantilevers. Three of the resilient plates 40 have round holes 42, which fix their corresponding corners in the Z direction, and also fix the entire mask diaphragm assembly in the X and Y directions. The fourth resilient plate has a slot 43 which fixes its corner in the Z direction, the position in the X and Y directions being fixed by the other three plates.

FIG. 3 shows the assembly of mask and frame in greater detail. Each long diaphragm 33 is formed by a base portion 34 and an upright flange 35, which meet at a right angle. Each short diaphragm 36 is formed by a base portion 37 and an upright flange 38, which meet at a right angle. The base portions 34, 37 are welded to the base 27 of the corner bracket 26. The upright flanges 35, 38 serve as mounting means for the mask 22, which is welded thereto. Only some of the apertures 23 for directing the electron beams are shown. The resilient plate 40 is welded to the bracket 26 as shown in FIG. 4, and is provided with a round aperture 42 which is aligned for mounting against the round head of pin 14 on the skirt 13.

During manufacture, the corner brackets 26 and plates 40 are placed on an assembly block which serves as a positioning jig (not shown), and the plates are welded to the respective corner brackets. The diaphragms are then welded to the corner brackets 26, and the completed frame is removed from the assembly block. The shadow mask 22 is then welded to the flanges 35, 38, and the assembly is placed in the skirt 13, with the plates 40 being resiled so that the holes 42 and slot 43 engage respective pins 14. The assembly is now ready for screening.

Screening is a well known process in which a photosensitive coating for each of the colors is exposed through the mask and developed. First a coating for one color of luminescing phosphors is exposed, then the mask/frame is removed and the coating is developed to leave the luminescing elements. Then a photosensitive coating for another color is coated over the elements, the mask/frame is replaced, and the coating is exposed through the mask. The mask/frame is removed and the coating developed. The process is repeated for the third color, then all of the phosphor elements are coated with a 200-500 mm thick layer of aluminum and the mask/frame is again placed on the pins 14. The internal magnetic shield 52 (FIG. 1) is then fixed to the frame by means of dart clips received through apertures 28, and the vacuum envelope 10 (FIG. 1) is sealed to the skirt and evacuated.

Each bracket 26 comprises a flat base portion 27 from which lateral flanges 32 are formed at substantially right angles, and mounting flange 30 is formed at an angle of about forty-five degrees. The flange 30 is provided with a mountings lab 31 to which the plate 40 is welded at welds 41. The plate 40 extents rearward as a cantilever and provides the spring force for loading the holes 42 (and slot 43, FIG. 2) against the pins.

FIG. 4 is a plan view of an embodiment of resilient plate 46 which carries a slide plate 48 having a formed boss (dome) 49 which engages the respective pin. The slide plate 48 can move in the X-Y plane by virtue of tabs 50 received through slots 47 in the TC plate. During manufacture, the slide plates 48 are welded to the plate 46, after the diaphragms are welded to the brackets, when the frame is initially placed on pins. This assures precise alignment with the face plate, but entails additional parts. FIG. 4A is a sectional view.

Inner magnetic shield 52 is shown in larger detail and in perspective view in FIG. 5. Shield 52 has a cone or funnel portion 53, which at its wider end 54 is provided with a flange 55.

In the embodiment of FIG. 5, flange 55 has a skirt 56. A skirt makes a flange more rigid, but can be omitted, if desired. Flange 55 is bevelled at its diagonal corner areas A, B, C and D (not visible). The corner areas skirtless and form the places where support members 60 have to be attached, e.g. by means of welding. The support members are attached to the lower surface of flange 55, remote from the cone portion 53.

As shown in FIG. 6, support member 60 has a (flat) base plate 57.

The base plate 57 is connected with a distal end 59 having near its free end an aperture 61 for mounting purposes. According to the invention distal end 59 has been bent into a V-shape.

Base plate 57 is attached to the side of flange 55, which is remote from cone portion 53. For the attachment four connections a, b, c, d have been used in the embodiment of FIG. 6. Connections a and b are located on a flange portion which in this example is parallel to the short side of the cone portion (parallel to the y-axis) and connections c and d are located on a flange portion which is parallel to the long side of the cone portion (parallel to the x-axis). The extreme connections a and d lie on an imaginary line L which crosses the wall of cone portion 53. If in an alternative embodiment line L was located at the outside of the wall of cone portion 53, it should be as close to the corner of the cone portion as possible.

Apart from a flat base plate for its attachment to the flange, an Internal Magnetic Shield support member may have extra attachment portions with which it can be attached to the skirt.

FIG. 7 shows a support member 70 which has bent down lips 71, 72 for attachment to a skirt. In this case V-shaped distal end 73 is connected to an (upstanding), inclined portion 74 of base plate 75.

Base plate 75 is asymmetrical, and has a short leg 76 and a long leg 77. If an asymmetrical support member has only one extra attachment portion it is preferably connected to the short leg. Distal end 73 has an aperture 78 for mounting purposes.

FIG. 8 shows a support member 80 which has a base plate 85 with a bevel 79 at which it is provided with a (bent down) inclined portion 84. Portion 84 is connected with a V-shaped distal end 83 and is provided with two side legs, or projections, 81, 82 for attachment to a skirt. Distal end 83 has an aperture 88 for mounting purposes.

FIG. 9 schematically shows, in cross-section, a resilient plate 40, which is connected to a corner bracket 26. Plate 40 is loaded, by means of spring means 75, on corner pin 14. Plate 40 is provided with a slideable plate (washer) 48 which has a dome shaped boss 49 for fixing plate 40 on the head of pin 14. It has been found to be advantageous to mount support member 60 of inner magnetic shield 52 on boss 49 by clicking distal end on it by means of its aperture 61. In alternative embodiments distal end 59 can be mounted directly on pin 14. (FIG. 10)

Mounting the Internal Magnetic Shield on the corner pins 14 by clicking the distal ends of its support members on the bosses of the slide plates used in mounting the shadow mask on the pins 14 is sometimes referred to as indirect mounting.

In a direct Internal Magnetic Shield mounting method the distal ends 59 of the support members of the Internal Magnetic Shield 52 engage the mounting pins 14 directly through their apertures 61 (see FIG. 10 in which for the same parts the same reference numerals have been used as in the previous Figs.).

Summarizing, the invention relates to a ferromagnetic shielding funnel having a flange at its wider end for reception within the conical portion of a cathode ray tube, the funnel having support members at the corner portions of its flange. Each support member has a base plate which is attached to the flange and a distal end which has been bent into a V-shape for bearing on a respective pin in the wall of the cathode ray tube. For preventing that the funnel comes loose from the pins, the support members comprise further attachment means with which they are attached to a skirt of the flange. Preferably, the base plate is attached to the flange by means of Internal Magnetic Shield as claimed in claim 1, wherein the base plate is attached to the flange by means of two first connections to a flange portion which is parallel to a long side of the cone portion and two second connections to a flange portion which is parallel to a short side of the cone portion. The extreme ones of these connections are preferably arranged such that bending of the flange at the corner portions is prevented.

1. Internal Magnetic Shield for a cathode ray tube, having a cone portion with two long sides and two short sides, and a flange at the wider end of the cone portion, the flange having four corner portions, each corner portion being bevelled and a metal support member being arranged at each of said corner portions, each metal support member having a base plate which is parallel to and attached to the side of the flange which is remote from the cone portion and a distal end having an aperture, characterized in that the distal end has been bent into a V-shape, the aperture being arranged in the portion of the distal end which is remote from the base plate.

2. Internal Magnetic Shield as claimed in claim 1, wherein
the flange has a skirt, the bevelled corner portions however being skirtless,
the metal support member comprising at least one further attachment portion, which is normal to the flange and is attached to the skirt.

3. Internal Magnetic Shield as claimed in claim 2, wherein the portion of the V-shaped distal end which is adjacent the base plate has a leg on at least one side which forms the at least one further attachment portion.

4. Internal Magnetic Shield as claimed in claim 2, wherein the base plate is provided with at least one portion which is bent away from the cone portion, said at least one bent away portion forming the further attachment portion.

5. Internal Magnetic Shield as claimed in claim 1, wherein the base plate is attached to the flange by means of two first connections to a flange portion which is parallel to a long side of the cone portion and two second connections to a flange portion which is parallel to a short side of the cone portion.

6. Internal Magnetic Shield as claimed in claim 5, wherein an imaginary line through those two of the first and second connections which are farthest from each other, if outside the cone portion, has a distance to the adjacent corner of the cone portion of at most 5 mm.

7. Internal Magnetic Shield as claimed in claim 5, wherein an imaginary line through those two of the first and second connections which are farthest from each other crosses the cone portion.

8. Internal Magnetic Shield as claimed in claim 1, wherein the periphery of the smaller end of the cone portion is closed.

9. A cathode ray tube having an Internal Magnetic Shield as claimed in claim 1.

10. A cathode ray tube as claimed in claim 9 comprising:
a vacuum envelope having a neck, a funnel, a substantially rectangular face plate with an inside surface, a skirt extending between said face plate and said funnel, and four pins extending inward from said skirt adjacent respective corners of said face plate;
a display screen on said inside surface, said display screen comprising a plurality of phosphor elements;
an electron gun assembly arranged in said neck for emitting electrons toward said display screen,
a color selection electrode mounted adjacent to said display screen on the pins and comprising a plurality of apertures which pass electrons toward the phosphor elements, wherein the distal end of each support member bears on a respective one of said pins.

11. A cathode ray tube as claimed in claim 10, wherein the distal end of each support member engages a respective one of said pins through its aperture.

12. A cathode ray tube as claimed in claim 10, further comprising a substantially rectangular supporting frame to which said color selection electrode is connected, said frame comprising four corners brackets, and four resilient plates fixed directly to respective corner brackets, each plate having aperture means engaging a respective one of said pins and being spring loaded thereagainst, wherein each of said aperture means comprises a floating washer, said floating washer being provided with a boss having an inner face which engages a respective one of said pins and an outer face which engages a respective end of said distal ends through its aperture.
